(19) United States
(12) Patent Application Publication
(10) Pub. No.: US 2021/0352927 A1
(43) Pub. Date: Nov. 18, 2021

(54) METHOD FOR PRODUCING OIL AND FAT COMPOSITION, METHOD FOR PRODUCING EDIBLE OIL AND FAT COMPOSITION, METHOD FOR PRODUCING FOOD, METHOD FOR ENHANCING SWEETNESS OF FOOD, AND COMPOSITION FOR ENHANCING SWEETNESS OF FOOD

(71) Applicant: J-OIL MILLS, Inc., Tokyo (JP)

(72) Inventors: Shun MATSUZAWA, Tokyo (JP); Masayoshi SAKAINO, Tokyo (JP); Misaki TSUJI, Tokyo (JP); Takahiro TOKUCHI, Tokyo (JP); Takashi SANO, Tokyo (JP)

(21) Appl. No.: 17/287,163

(22) PCT Filed: Oct. 24, 2019
(86) PCT No.: PCT/JP2019/041655

§ 371 Date: Apr. 21, 2021

(30) Foreign Application Priority Data
Oct. 31, 2018 (JP) 2018-206132

(51) Int. Cl. A23D 9/007; A23D 9/04; A23L 29/00; A23L 27/30

(52) U.S. Cl. CPC A23D 9/007; A23L 27/30; A23L 29/04; A23D 9/04

(57) ABSTRACT

Provided is an edible material having an exceptional sweetness-enhancing effect. This method for producing an oil and fat composition is characterized in comprising a step for adding a carotenoid to an edible oil and fat, and a step for decomposing the carotenoid in the edible oil and fat. The carotenoid is preferably one or more selected from the group consisting of β-carotene, α-carotene, retinol, lutein, canthaxanthin, β-cryptoxanthin, bixin, norbixin, astaxanthin, zeaxanthin, fucoxanthin, violaxanthin, lycopene, crocin, crocetin, and capsanthin.

### TECHNICAL FIELD

The present invention relates to a carotenoid-derived material having an exceptional sweetness-enhancing effect, and usage thereof.

### BACKGROUND ART

Various edible materials having an exceptional effect for enhancing sweetness are known in the art. For example, patent document 1 discloses a method of enhancing the sweetness of a food using a long-chain highly unsaturated fatty acid and/or ester thereof. Also, for example, patent document 2 discloses a sweetness and/or milk flavor enhancer containing, as an active ingredient, an oxidized partially hydrogenated oil and fat having a peroxide value of 25 to 300. Also, for example, patent document 3 discloses a sweetness and/or salty taste enhancer containing, as an active ingredient, an oxidized oil and fat having a peroxide value of 15 to 180 and containing 10 mass % or more and 100 mass % or less of milk fat.

### RELATED ART DOCUMENTS

### Patent Documents

Patent Document 1: Japanese Laid-Open Patent Application No. 2009-284859
Patent Document 2: International Publication No. 2014/077019
Patent Document 3: International Publication No. 2018/037926

### DISCLOSURE OF THE INVENTION

### Problems the Invention is Intended to Solve

However, in view of an increased diversity of consumer tastes and needs from food business operators, there has been a need to provide new materials having different origins from the conventional materials.

Consequently, the purpose of the present invention is to provide an edible material with an exceptional effect for enhancing sweetness.

### Means for Solving the Aforementioned Problems

A first aspect of the present invention provides a method for producing an oil and fat composition, characterized in comprising a step for adding a carotenoid to an edible oil and fat, and a step for decomposing the carotenoid in the edible oil and fat.

In the method for producing an oil and fat composition, it is preferred that the carotenoid is one or more selected from the group consisting of β-carotene, α-carotene, retinol, lutein, canthaxanthin, β-cryptoxanthin, bixin, norbixin, astaxanthin, zeaxanthin, fucoxanthin, violaxanthin, lycopene, crocin, crocetin, and capsanthin.

In the method for producing an oil and fat composition, it is preferred that, in the adding step, 0.003 mass % or more and 3 mass % or less of the carotenoid is added to edible oil and fat.

In the method for producing an oil and fat composition, it is preferred that the edible oil and fat preferably has an iodine value of 0 or more and 140 or less.

In the method for producing an oil and fat composition, it is preferred that the edible oil and fat is one or more selected from the group consisting of medium-chain fatty acid triglycerides, coconut oil, palm mid fraction (sPMF), fully hydrogenated palm kernel oil, rapeseed oil, and palm olein.

In the method for producing an oil and fat composition, it is preferred that the step for decomposition is carried out at a heating temperature of 50° C. or higher and 220° C. or lower, and a heating time of 0.1 hour or more and 240 hours or less.

In the method for producing an oil and fat composition, it is preferred that the step for decomposition is carried out by supplying oxygen to the edible oil and fat.

A second aspect of the present invention provides a method for producing an edible oil and fat composition, comprising a step for adding the oil and fat composition obtained by the production method described above to an edible oil and fat.

In the method for producing an edible oil and fat composition, it is preferred that 1×10⁻¹⁰ mass % or more and less than 100 mass % of the oil and fat composition is added.

Furthermore, a third aspect of the present invention provides a method for producing a food, comprising a step for admixing, in a food, the oil and fat composition or the edible oil and fat composition obtained by the production method described above.

In the method for producing a food described above, it is preferred that 1×10⁻¹⁰ mass % or more and 50 mass % or less of the oil and fat composition is admixed.

Moreover, a fourth aspect of the present invention provides a method for enhancing food sweetness, wherein an oil and fat composition or an edible oil and fat composition obtained by the production method described above is included in a food.

In the method for enhancing food sweetness, it is preferred that the oil and fat composition or the edible oil and fat composition is included in the food so that the total amount of the carotenoid and a decomposition product thereof is 1×10⁻¹⁵ mass % or more and 1.5 mass % or less as an amount expressed as the carotenoid amount prior to the decomposition step.

Furthermore, a fifth aspect of the present invention provides a composition for enhancing food sweetness containing a carotenoid decomposition product.

In the composition for enhancing food sweetness, it is preferred that the carotenoid is one or more selected from the group consisting of β-carotene, α-carotene, retinol, lutein, canthaxanthin, β-cryptoxanthin, bixin, norbixin, astaxanthin, zeaxanthin, fucoxanthin, violaxanthin, lycopene, crocin, crocetin, and capsanthin.

### Effect of the Invention

According to the present invention, it is possible to provide an edible material having an exceptional effect of enhancing sweetness by deriving a carotenoid also known as an edible pigment.

### BRIEF DESCRIPTION OF THE DRAWINGS

FIG. 1 is a chart showing the results of a sensory evaluation of the sweetness of chocolate by the Time Intensity method in Test Example 7.

### BEST MODE FOR CARRYING OUT THE INVENTION

In the present invention, a carotenoid is added to an edible oil and fat, and the carotenoid in the edible oil and fat is decomposed to obtain an oil and fat composition containing a decomposition product of the carotenoid. The oil and fat composition obtained in this manner has functionality for enhancing sweetness.

Examples of the carotenoid used in the present invention include β-carotene, α-carotene, retinol, lutein, canthaxanthin, βR-cryptoxanthin, bixin, norbixin, astaxanthin, zeaxanthin, fucoxanthin, violaxanthin, lycopene, crocin, crocetin, and capsanthin. One or more selected from the group consisting of β-carotene, α-carotene, retinol, astaxanthin, zeaxanthin, lycopene, crocin, and capsanthin is preferred, one or more selected from the group consisting of β-carotene, α-carotene, retinol, and astaxanthin is more preferred, and β-carotene is even more preferred. Any edible pigment or the like authorized and approved as a food additive can be more preferably used as the carotenoid because the food safety thereof has been generally confirmed. The carotenoid may be a single type used alone, or two or more types used in combination and decomposed in a mixed state.

An edible oil and fat well known to a person skilled in the art can be used, as appropriate, as the edible oil and fat used in the present invention. Examples include: soybean oil, rapeseed oil (canola oil), palm oil, corn oil, olive oil, sesame oil, safflower oil, sunflower oil, cottonseed oil, rice bran oil, peanut oil, palm kernel oil, coconut oil, and other vegetable oils; beef tallow, pork fat, chicken fat, milk fat, and other animal fats; medium-chain fatty acid triglycerides; and processed oils and fats obtained by subjecting these oils and fats to separation, hydrogenation, transesterification, or the like. The oil and fat may be a single type used alone, or two or more types mixed together. Among these, the edible oil and fat preferably has an iodine value (hereinafter, may be referred to as “IV”) of 0 or more and 140 or less. The iodine value can be measured according to “Standard Methods for the Analysis of Fat, Oil and Related Materials, 2.3.4 Iodine Value” (Japan Oil Chemists' Society).

In a more preferred embodiment, the edible oil and fat is preferably one or more selected from the group consisting of medium-chain fatty acid triglycerides, coconut oil, palm mid fraction (sPMF), fully hydrogenated palm kernel oil, rapeseed oil, and palm olein, more preferably one or more selected from the group consisting of medium-chain fatty acid triglycerides, sPMF, and palm olein, and particularly preferred are medium-chain fatty acid triglycerides.

The amount of the carotenoid added to the edible oil and fat (as the total amount added when two or more types are decomposed in a mixed state) is preferably added so that the content of the carotenoid is 0.003 mass % or more and 3 mass % or less, more preferably 0.003 mass % or more and 2 mass % or less, even more preferably 0.003 mass % or more and 1 mass % or less, and particularly preferably 0.003 mass % or more and 0.8 mass % or less.

There is no particular limitation as to the means for decomposing the carotenoid in the edible oil and fat, but the means is preferably a heat treatment, and in terms of industrial scale production, the carotenoid and edible oil and fat are accommodated in a tank or other suitable container, after which the predetermined heat treatment is preferably carried out using an electrothermal type, direct flame burner type, microwave type, steam type, hot-air type, or other heating means provided to the container. The conditions of the heat treatment can be set, as appropriate, so as to obtain a desired amount of the resulting product (e.g., a carotenoid decomposition product). The conditions of the heat treatment cannot be specified unconditionally and depends on the type of carotenoid and the type of edible oil and fat used as the base oil, but heating is typically carried out at temperature of, e.g., 50° C. or higher and 220° C. or lower and a heating time of 0.1 hour or more and 240 hours or less. Heating is more typically carried out at temperature of, e.g., 60° C. or higher and 160° C. or lower and a heating time of 1 hour or more and 100 hours or less. As a condition of the integral amount of heating temperature (° C.)×heating time (hours), heat treatment is typically carried out with an integral amount of, e.g., 200 or more and 20,000 or less, and heat treatment is more typically carried out with an integral amount of, e.g., 300 or more and 16,000 or less. The heat treatment is even more typically carried out with an integral amount of, e.g., 400 or more and 14,000 or less. When the heating temperature is changed, the integral amount of heating temperature (° C.)×heating time (hours) can be calculated as an integral value of the heating temperature (° C.) prior to the temperature change×the heating time (hours) prior to the temperature change, and the heating temperature (° C.) after the temperature change×the heating time (hours) after the temperature change, otherwise can be alternatively calculated as an integral value of the heating temperature (° C.) over heating time (hours).

Further, in the heat treatment, oxygen (air) can be supplied by blowing oxygen, or by stirring to take in oxygen from an open space in the container. The oxygen source can be air or the like. Decomposition of the carotenoid is thereby promoted. In such a case, the amount of air to be supplied is preferably 0.001 to 2 L/min. per 1 kg of starting material oil and fat composition. For example, in the case of air, the amount is preferably 0.005 to 10 L/min., and is more preferably 0.01 to 5 L/min., per 1 kg of the starting material oil and fat composition.

The oil and fat composition containing the carotenoid-derived product obtained in the manner described above can be further added to another edible oil and fat to obtain an edible oil and fat composition containing the oil and fat composition. Examples of the other edible oil and fat for producing the edible oil and fat composition include: soybean oil, rapeseed oil (canola oil), palm oil, corn oil, olive oil, sesame oil, safflower oil, sunflower oil, cottonseed oil, rice bran oil, peanut oil, palm kernel oil, coconut oil, and other vegetable oils; beef tallow, pork fat, chicken fat, fish oil, milk fat, and other animal fats; medium-chain fatty acid triglycerides; and processed oils and fats obtained by subjecting these oils and fats to separation, hydrogenation, transesterification, or the like. The other edible oil and fat may be a single type used alone, or two or more types mixed together. There is no particular limitation as to the blending ratio, but the amount of the oil and fat composition containing the carotenoid-derived product with respect to the total mass of the oil and fat composition containing the carotenoid-derived product and the other edible oil and fat is preferably 1×10⁻¹⁰ mass % or more and less than 100 mass %, more preferably 1×10⁻⁹ mass % or more and less than 100 mass %, further preferably 1×10⁻⁹ mass % or more and less than 100 mass %, and even more preferably 1×10⁻⁷ mass % or more and less than 100 mass %. In the edible oil and fat composition, one type of oil and fat composition containing the carotenoid-derived product may be included in the other edible oil and fat, or two or more types may be used in combination.

A suitable additive material can be blended, as appropriate, into the oil and fat composition containing the carotenoid-derived product obtained in the manner described above and to the edible oil and fat composition containing the same, in a range that does not compromise the desired sweetness-enhancing functionality. Specific examples include: ascorbic acid fatty acid ester, lignan, coenzyme Q, γ-oryzanol, tocopherol, and other antioxidants; flavoring, spice extract, animal extract, fatty acid, and other flavor imparting material; and emulsifier, silicone, pigment, and the like.

There is no particular limitation as to the form of the oil and fat composition containing the carotenoid-derived product obtained in the manner described above and the edible oil and fat composition containing the same; examples include margarine, shortening, fat spread, and powdered oil and fat. The composition can be used in various foods, and can be used particularly for the purpose of enhancing sweetness. In other words, an oil and fat composition containing the above carotenoid-derived product or a component derived from an edible oil and fat composition containing the same can be added to the food to enhance the sweetness of the food by using the composition as: a loosening oil, rice cooking oil, frying oil, roasting oil, or other cooking oil; or kneading oil, injection oil, finishing oil, or other seasoning oil or the like in cooking, processing, or manufacturing of various foods, and alternatively in adding, mixing, applying, dissolving, dispersing, emulsifying, or otherwise incorporating the composition in a food after cooking, processing, or manufacturing various foods. There is no particular limitation as to the food obtained by application of the present invention; examples include cakes, breads, donuts, and other bakery foods; whipped cream, hot cakes, madeleines, chocolates, cookies, and other western confectioneries; yogurt, almond tofu, pudding, jelly, and other cold confectioneries; ice cream, ice milk, lacto ice cream, and other ice confectioneries; corn soup, consommé soup, and other soups; beef stew, cream stew, and other stews; coffee drinks, milk drinks, and other beverages; grilled pork, roasted pork fillet, and other processed meat foods; beef cutlets, pork cutlets, chicken cutlets, deep fried chicken, Tatsuta fried chicken, and other stir fry foods; and kamaboko, fish sausage, and other processed marine foods. Particularly preferred among these are western confectioneries, cold confectioneries, ice confectioneries, soups, beverages, fried foods, and the like.

There is no particular limitation as to the blending ratio in a food; the amount of the oil and fat composition containing the carotenoid-derived product with respect to the total mass of the oil and fat composition containing the carotenoid-derived product and the food to be added with the same is preferably 1×10⁻¹⁰ mass % or more and less than 50 mass % or less, more preferably 1×10⁻⁹ mass % or more and 50 mass % or less, further preferably 1×10⁻⁸ mass % or more and 50 mass % or less, and even more preferably 1×10⁻⁷ mass % or more and 50 mass % or less. Using the above carotenoid-derived product as an index, the oil and fat composition containing the carotenoid-derived product is preferably included in the food so that the total amount of the carotenoid and a decomposition product thereof is preferably 1×10⁻¹⁵ mass % or more and 1.5 mass % or less as an amount expressed as the carotenoid amount prior to the decomposition step, more preferably 1×10⁻¹⁴ mass % or more and 1.5 mass % or less, further preferably 1×10⁻¹³ mass % or more and 1.5 mass % or less, and even more preferably 1×10⁻¹² mass % or more and 1.5 mass % or less.

In another aspect of the present invention, the oil and fat composition obtained in the manner described above and the edible oil and fat composition containing the same contain a carotenoid decomposition product, which is considered to be a component involved in exhibiting a sweetness-enhancing effect, and can therefore be used for enhancing the sweetness of a food. In other words, the carotenoid decomposition product can be used, e.g., in the form of a composition for enhancing the sweetness of a food containing the same.

Examples of the carotenoid used for such a purpose include β-carotene, α-carotene, retinol, lutein, canthaxanthin, β-cryptoxanthin, bixin, norbixin, astaxanthin, zeaxanthin, fucoxanthin, violaxanthin, lycopene, crocin, crocetin, and capsanthin. Any edible pigment or the like authorized and approved as a food additive can be more preferably used as the carotenoid because the food safety thereof has been generally confirmed. The carotenoid can be a single type used alone, or two or more types used in combination.

The carotenoid decomposition product can be obtained by a predetermined heat treatment or the like, which is carried out while arbitrarily blowing oxygen (air) in the same manner as the above-described oil and fat composition containing a carotenoid-derived product. The decomposition product may be extracted or concentrated, as appropriate, from the oil and fat composition containing the above-described carotenoid-derived product. There is no particular limitation as to the extraction and concentration methods; it is possible to use, e.g., an extraction method that uses an organic solvent, column chromatography, molecular distillation, or steam distillation.

When the carotenoid decomposition product is used in the form of a composition for enhancing the sweetness of food, there is no particular limitation as to the formulated form as long as the form can be used in foods and keep the carotenoid decomposition product stable or in a well-dispersed state. For example, a liquid oil and fat, margarine, fast spread, shortening, powdered oil and fat, etc., which are mainly composed of oil and fat, may be prepared by a formulation technique well known to a person skilled in the art, and may alternatively be prepared in the form of a solution, powder, gel, granule, or the like in which the blended amount of the oil and fat component is low, and these forms can be arbitrarily used. The above-mentioned oil and fat composition containing a carotenoid-derived product and edible oil and fat composition containing the same may be used unchanged as a form for using the carotenoid decomposition product to enhance the sweetness of food.

The amount of the carotenoid decomposition product in the composition for enhancing the sweetness of a food can be determined in terms of a suitable amount desired when applied to the food, and is not particularly limited. Typically, the amount is, e.g., preferably 1×10⁻¹⁵ mass % or more and 100 mass % or less, more preferably 1×10⁻¹⁴ mass % or more and 100 mass % or less, further preferably 1×10⁻¹³ mass % or more and 100 mass % or less, and even more preferably 1×10⁻¹² mass % or more and 100 mass % or less.

The usage mode of the composition for enhancing the sweetness of a food is the same as the oil and fat composition containing the carotenoid-derived product and the edible oil and fat composition containing the same, and can be used, as appropriate, so that the food contains a desired amount. In such a case, in terms of the sweetness-enhancing effect, the composition for enhancing the sweetness of a food is preferably included in the food so that the carotenoid decomposition product is 1×10⁻⁵ mass % or more and 1.5 mass % or less, more preferably 1×10⁻¹⁴ mass % or more and 1.5 mass % or less, further preferably 1×10⁻¹³ mass % or more and 1.5 mass % or less, and even more preferably 1×10⁻¹² mass % or more and 1.5 mass % or less.

### EXAMPLES

Hereinbelow, the present invention will be described in greater detail using examples, but these examples do not limit the present invention in any way.

First, the carotenoids and base oils as edible oils/fats used in the present example will be listed.

[Base Oils and Carotenoids]
MCT: Medium-chain fatty acid triglyceride, trade name “Coconard MT”, IV=0, manufactured by Kao Corporation
Coconut oil: IV=10, manufactured by J-Oil Mills Inc. (in-house preparation)
fully hydrogenated palm kernel oil: IV=2, manufactured by J-Oil Mills Inc. (in-house preparation)
sPMF: IV=43, manufactured by J-Oil Mills Inc. (in-house preparation)
Rapeseed oil: AJINOMOTO smooth canola oil, IV=115, manufactured by J-Oil Mills Inc.
Palm olein: IV=58, manufactured by J-Oil Mills Inc. (in-house preparation)
β-carotene: 30% β-carotene suspension (manufactured by DSM)
α-carotene: Reagent for α-carotene (model number 035-17981) (manufactured by Wako Pure Chemical Industries, Ltd.)
Lycopene: Reagent for lycopene (model number 125-04341) (manufactured by Wako Pure Chemical Industries, Ltd.)
Retinol: Retinol (model number R7632) (manufactured by SIGMA)
Astaxanthin: Astaxanthin oil Astabio AR5 (manufactured by Biogenic Co., Ltd.)
Zeaxanthin: OPTISHARP NAT. ZEA. 14% SAFF. (manufactured by DSM)
Capsanthin: Orange Color 100-OIL-EX (manufactured by Kiriya Chemical Co., Ltd.)
Crocin: Kiriyasu Oil Yellow GY (manufactured by Kiriya Chemical Co., Ltd.)

[Quantification of α-Carotene, β-Carotene, and Lycopene]

The method for quantifying α-carotene, β-carotene, and lycopene will be described below. Quantification was carried out by analysis by high-performance liquid chromatography (HPLC analysis). Specifically, 0.5 g of a carotenoid, edible oil and fat to which the carotenoid has been added, or oxidation-treated oil and fat composition were weighed, each was diluted in a measuring flask in 10 mL of acetone and tetrahydrofuran in a 1:1 ratio, and subjected to HPLC analysis to quantify the contents of α-carotene, β-carotene and lycopene from a calibration curve. The calibration curve uses reagents of α-carotene (model number 035-17981), β-carotene (model number 035-05531), and lycopene (model number 125-04341) (manufactured by Wako Pure Chemical Industries, Ltd.) as quantitative samples, and was created from a peak area when subjected to HPLC analysis for each predetermined concentration. The main analysis conditions are shown below.

(HPLC Conditions)
Detector: Photodiode array detector “2996 PHOTODIODE ARRAY DETECTOR” (Waters), detected at 300-600 nm.
Column: Shim-pack VP-ODS, 4.6 mm ID×250 mm, 4.6 μm (Shimadzu Corporation)
Column temperature: 50° C.
Injection amount: 5 μL
Flow rate: 1.2 mL/min.
Mobile phase A: acetonitrile
Mobile phase B: ethanol
Mobile phase C: acetone
Gradient conditions: See Table 1

TABLE 1
Gradient conditions

| Minutes | A (capacity %) | B (capacity %) | C (capacity %) |
|---|---|---|---|
| 0 | 80 | 20 | 0 |
| 22.0 | 80 | 20 | 0 |
| 22.1 | 0 | 0 | 100 |
| 25.0 | 0 | 0 | 100 |
| 25.1 | 80 | 20 | 0 |
| 30.0 | 80 | 20 | 0 |

[Quantification of Retinol, Astaxanthin, Zeaxanthin and Capsanthin]

The method for quantifying retinol, astaxanthin, zeaxanthin, and capsanthin will be described below. Quantification was carried out by analysis by high-performance liquid chromatography (HPLC analysis). Specifically, 2 g of a carotenoid, edible oil and fat to which the carotenoid has been added, or oxidation-treated oil and fat composition were weighed, each was diluted in 10 mL of acetone in a measuring flask, and dissolved and subjected to HPLC analysis to quantify the contents of retinol, astaxanthin, zeaxanthin, and capsanthin from a calibration curve. The calibration curve uses reagents of retinol (model number R7632) (manufactured by SIGMA), astaxanthin (model number 600113) (manufactured by MedKoo Biosciences), zeaxanthin (model number 0307S) (manufactured by EXTRASYNTHESE), and capsanthin (model number 207-364-1) (manufactured by LKL Laboratories, Inc.) as quantitative samples, and was created from a peak area when subjected to HPLC analysis for each predetermined concentration. The main analysis conditions are shown below.

(HPLC Conditions)
Detector: Photodiode array detector “2996 PHOTODIODE ARRAY DETECTOR” (Waters), detected at 400-600 nm.
Column: YMC Carotenoid, 4.6 mm ID×250 mm, 5 μm (YMC Co., Ltd.)
Column temperature: 25° C.
Injection amount: 10 μL
Flow rate: 1.0 mL/min.
Mobile phase A: methanol
Mobile phase B: tert-butylmethyl ether
Mobile phase C: ultrapure water
Gradient conditions: See Table 2

TABLE 2
Gradient conditions

| Minutes | A (capacity %) | B (capacity %) | C (capacity %) |
|---|---|---|---|
| 0 | 81 | 15 | 4 |
| 90.0 | 6 | 90 | 4 |
| 95.0 | 6 | 90 | 4 |
| 95.1 | 81 | 15 | 4 |
| 105.0 | 81 | 15 | 4 |

[Measurement of Iodine Value (IV)]

The base oil IV was measured in accordance with “Standard Methods for the Analysis of Fat, Oil and Related Materials, 2.3.4 Iodine Value” (Japan Oil Chemists' Society).

### Test Example 1

Various oil and fat compositions were prepared according to the blends shown in Table 3. Specifically, carotenoids were added to the base oil so as to have a predetermined content (mass ppm) and a total of 240 g, and the blends were heat-treated under the heat treatment conditions shown in Table 3 while stirring to obtain the oil and fat compositions of Examples 1 to 24. Except for Example 17, the treatment was performed while supplying air (200 mL/min). In addition, as Comparative Example 1 in which heat treatment was not performed, @-carotene was added to a medium-chain fatty acid triglyceride (MCT) so as to have a content of 53 mass ppm, and mixed by gentle stirring without other heating and the like to prepare an oil and fat composition.

Table 3 shows the types of carotenoids, the types of base oils (iodine values thereof), the quantitatively measured values of carotenoid content in the composition prior to heat treatment, and the heat treatment conditions. The crocin content is a value calculated from the addition amount.

TABLE 3

| | | | Carotenoid | Heat treatment conditions | |
|---|---|---|---|---|---|
| | Added | | content | | Air-blow |
| | carotenoid | Base oil | (mass ppm) | Temperature and hours | rate |
| Comparative | β-carotene | MCT (IV: 0) | 53 | — | — |
| Example 1 | | | | | |
| Example 1 | Retinol | MCT (IV: 0) | 45 | 120° C. (5 h) → 80° C. (5 h) | 0.2 L/min |
| Example 2 | Astaxanthin | MCT (IV: 0) | 45 | 120° C. (5 h) → 80° C. (5 h) | 0.2 L/min |
| Example 3 | Zeaxanthin | MCT (IV: 0) | 45 | 120° C. (5 h) → 80° C. (5 h) | 0.2 L/min |
| Example 4 | α-carotene | MCT (IV: 0) | 44 | 120° C. (5 h) → 80° C. (5 h) | 0.2 L/min |
| Example 5 | Lycopene | MCT (IV: 0) | 33 | 120° C. (5 h) → 80° C. (5 h) | 0.2 L/min |
| Example 6 | Crocin* | MCT (IV: 0) | 45 | 120° C. (5 h) → 80° C. (5 h) | 0.2 L/min |
| Example 7 | Capsanthin | MCT (IV: 0) | 45 | 120° C. (5 h) → 80° C. (5 h) | 0.2 L/min |
| Example 8 | β-carotene | MCT (IV: 0) | 53 | 120° C. (5 h) | 0.2 L/min |
| Example 9 | β-carotene | MCT (IV: 0) | 53 | 120° C. (5 h) → 80° C. (2 h) | 0.2 L/min |
| Example 10 | β-carotene | MCT (IV: 0) | 53 | 120° C. (5 h) → 80° C. (5 h) | 0.2 L/min |
| Example 11 | β-carotene | MCT (IV: 0) | 31 | 120° C. (6 h) | 0.2 L/min |
| Example 12 | β-carotene | MCT (IV: 0) | 60 | 120° C. (7 h) | 0.2 L/min |
| Example 13 | β-carotene | MCT (IV: 0) | 88 | 120° C. (14 h) | 0.2 L/min |
| Example 14 | β-carotene | MCT (IV: 0) | 436 | 120° C. (7 h) | 0.2 L/min |
| Example 15 | β-carotene | MCT (IV: 0) | 5531 | 120° C. (11 h) | 0.2 L/min |
| Example 16 | β-carotene | MCT (IV: 0) | 28213 | 120° C. (7 h) | 0.2 L/min |
| Example 17 | β-carotene | MCT (IV: 0) | 60 | 120° C. (7 h) | None |
| Example 18 | β-carotene | MCT (IV: 0) | 60 | 80° C. (172 h) | 0.2 L/min |
| Example 19 | β-carotene | MCT (IV: 0) | 60 | 140° C. (3 h) | 0.2 L/min |
| Example 20 | β-carotene | Coconut oil | 53 | 120° C. (5 h) → 80° C. (5 h) | 0.2 L/min |
| | | (IV: 10) | | | |
| Example 21 | β-carotene | fully | 53 | 120° C. (5 h) → 80° C. (5 h) | 0.2 L/min |
| | | hydrogenated | | | |
| | | palm kernel | | | |
| | | oil (IV: 2) | | | |
| Example 22 | β-carotene | sPMF (IV: 43) | 53 | 120° C. (5 h) → 80° C. (5 h) | 0.2 L/min |
| Example 23 | β-carotene | Rapeseed oil | 53 | 120° C. (5 h) → 80° C. (5 h) | 0.2 L/min |
| | | (IV: 115) | | | |
| Example 24 | β-carotene | Palm olein | 53 | 120° C. (5 h) → 80° C. (5 h) | 0.2 L/min |
| | | (IV: 58) | | | |

*Crocin: The crocin content is calculated from the addition amount.

(Sensory Evaluation)

A sensory evaluation was conducted for the oil and fat compositions of Comparative Example 1 and Examples 1 to 24. Specifically, the oil and fat composition was added to corn soup (corn soup was prepared by adding 150 mL of hot water to Knorr cup soup corn cream, manufactured by Ajinomoto Co., Inc., 17.6 g of powdered corn soup) and consumed. The intensity of sweetness in each of the first taste, the middle taste, and the aftertaste was evaluated by relative comparison with the case in which the oil and fat composition was not added. The sensory evaluation was conducted by an expert panel of 4 or 5 people, and the median value was calculated by scoring according to the following criteria. In addition, the obtained median value results were ranked on the following five-point scale.

(Criteria)

3 Very intense

2 Intense

1 Somewhat intense

0 Same

−1 Somewhat weak

−2 Weak

−3 Very weak

(Five-Point Scale)

A 2≤Median value

B 1<Median value<2

C 0.75≤Median value≤1

D 0<Median value<0.75

E −3≤Median value≤0

The results are shown in Table 4.

TABLE 4

| | | | | | | Median value of | | | Result of sensory | | |
|---|---|---|---|---|---|---|---|---|---|---|---|
| | | | | Corn soup | | sensory evaluation | | | evaluation | | |
| | | | Carotenoid | Content of | Carotenoid | (n = 4 or 5) | | | (5-point scale) | | |
| | Added | | content** | oil and fat | content*** | First | Middle | After | First | Middle | After |
| | carotenoid | Base oil | (mass ppm) | composition | (mass ppm) | taste | taste | taste | taste | taste | taste |
| Comparative | β-carotene | MCT (IV: 0) | 53 | 500 | 0.03 | 0.5 | 0.5 | 0.5 | D | D | D |
| Example 1 | | | | | | | | | | | |
| Example 1 | Retinol | MCT (IV: 0) | 45 | 500 | 0.02 | 1.25 | 1.5 | 0.75 | B | B | C |
| Example 2 | Astaxanthin | MCT (IV: 0) | 45 | 500 | 0.02 | 0.75 | 1.25 | 1.25 | C | B | B |
| Example 3 | Zeaxanthin | MCT (IV: 0) | 45 | 500 | 0.02 | 0.25 | 0.75 | 0.75 | D | C | C |
| Example 4 | α-carotene | MCT (IV: 0) | 44 | 500 | 0.02 | 1.25 | 1 | 1.25 | B | C | B |
| Example 5 | Lvcopene | MCT (IV: 0) | 33 | 500 | 0.02 | 0.25 | 0.75 | 0.5 | D | C | D |
| Example 6 | Crocin* | MCT (IV: 0) | 45 | 500 | 0.02 | 0.5 | 0.75 | 0.75 | D | C | C |
| Example 7 | Capsanthin | MCT (IV: 0) | 45 | 500 | 0.02 | 0.75 | 0.75 | 0.75 | C | C | C |
| Example 8 | β-carotene | MCT (IV: 0) | 53 | 500 | 0.03 | 1 | 1.5 | 1 | C | B | C |
| Example 9 | β-carotene | MCT (IV: 0) | 53 | 500 | 0.03 | 1 | 1.5 | 1.5 | C | B | B |
| Example 10 | β-carotene | MCT (IV: 0) | 53 | 500 | 0.03 | 1.75 | 2 | 2 | B | A | A |
| Example 11 | β-carotene | MCT (IV: 0) | 31 | 500 | 0.02 | 1.25 | 1.75 | 1.5 | B | B | B |
| Example 12 | β-carotene | MCT (IV: 0) | 60 | 500 | 0.03 | 1 | 1.75 | 1.75 | C | B | B |
| Example 13 | β-carotene | MCT (IV: 0) | 88 | 200 | 0.02 | 2 | 1.25 | 1.5 | A | B | B |
| Example 14 | β-carotene | MCT (IV: 0) | 436 | 40 | 0.02 | 1.25 | 1.75 | 1.25 | B | B | B |
| Example 15 | β-carotene | MCT (IV: 0) | 5531 | 4 | 0.02 | 1.5 | 2 | 2 | B | A | A |
| Example 16 | β-carotene | MCT (IV: 0) | 28213 | 0.7 | 0.02 | 1.5 | 2 | 2.5 | B | A | A |
| Example 17 | β-carotene | MCT (IV: 0) | 60 | 500 | 0.03 | 1.25 | 1.5 | 1.5 | B | B | B |
| Example 18 | β-carotene | MCT (IV: 0) | 60 | 500 | 0.03 | 1 | 1.75 | 1.5 | C | B | B |
| Example 19 | β-carotene | MCT (IV: 0) | 60 | 500 | 0.03 | 1.25 | 1.75 | 2 | B | B | A |
| Example 20 | β-carotene | Coconut oil | 53 | 500 | 0.03 | 1 | 1 | 1.5 | C | C | B |
| | | (IV: 10) | | | | | | | | | |
| Example 21 | β-carotene | fully hydrogenated | 53 | 500 | 0.03 | 1 | 1 | 1 | C | C | C |
| | | palm kernel oil | | | | | | | | | |
| | | (IV: 2) | | | | | | | | | |
| Example 22 | β-carotene | sPMF (IV: 43) | 53 | 500 | 0.03 | 1 | 1.5 | 1.25 | C | B | B |
| Example 23 | β-carotene | Rapeseed oil | 53 | 500 | 0.03 | 1 | 1.25 | 1.5 | C | B | B |
| | | (IV: 115) | | | | | | | | | |
| Example 24 | β-carotene | Palm olein | 53 | 500 | 0.03 | 0.75 | 1.25 | 1 | C | B | C |
| | | (IV: 58) | | | | | | | | | |

*Crocin: The crocin content is calculated from the addition amount.
**Carotenoid content in the oil and fat composition: Amount converted to the amount prior to heat treatment
***Carotenoid content in the corn soup: Amount converted to the amount prior to heat treatment

As a result, in Comparative Example 1, in which β-carotene was added to the base oil to prepare the oil and fat composition without heating or other treatment, the first taste, the middle taste, and the aftertaste when the corn soup is consumed were judged to be D on the 5-point scale of sweetness, and the effect of enhancing the sweetness of corn soup was poor. On the other hand, in Examples 1 to 24, in which a carotenoid was added to the base oil and then subjected to a certain degree of heat treatment to prepare an oil and fat composition, the first taste, the middle taste, and the aftertaste when the corn soup is consumed were judged to be A, B, or C on the 5-point scale of sweetness, and depending on the type of carotenoid or base oil used and the degree of heat treatment, a better judgment of B or even better judgment of A were also obtained. From this result, it was apparent that the oil and fat composition of the present invention has a sweetness-enhancing effect on the first taste, the middle taste, and the aftertaste of corn soup.

Moreover, from the comparison of Examples 8 to 10 in which carotenoids and base oils of the same type and content were used and the degree of heat treatment was changed, the effect of enhancing sweetness tended to increase as the degree of heat treatment was increased.

In particular, as seen in Example 11, 500 mass ppm (0.02 mass ppm in terms of β-carotene amount before heat treatment) of the oil and fat composition, which was prepared by adding 31 mass ppm of β-carotene to the base oil and heat-treating the combination, was added as the oil and fat composition in corn soup, whereby a relatively good sweetness-enhancing effect was obtained (first taste: B, middle taste: B, aftertaste: B). As seen in Example 16, 0.7 mass ppm (0.02 mass ppm in terms of β-carotene amount before heat treatment) of the oil and fat composition, which was prepared by adding 28213 mass ppm of β-carotene to the base oil and heat-treating the combination, was added as the oil and fat composition in corn soup, whereby a very good sweetness-enhancing effect was obtained (first taste: B, middle taste: A, aftertaste: A).

### Test Example 2

(Evaluation with Yogurt)

<Preparation of Edible Oil and Fat Composition>

The oil and fat composition of Example 17 prepared in Test Example 1 was admixed at 1 mass % in the rapeseed oil, and an edible oil and fat composition was prepared containing a carotenoid-derived product content of 6.0×10⁻⁵ mass % as an amount expressed as the carotenoid amount prior to heat treatment.

<Preparation and Evaluation of Yogurt)

The edible oil and fat composition prepared above (indicated in Table 5 as “rapeseed oil (containing 1 mass % of the ‘oil and fat composition of Example 17’)”) with the blends shown in Table 5 was included in yogurt (Meiji Bulgaria yogurt LB81 low sugar, manufactured by Meiji Co., Ltd.) to prepare yogurt, and the resulting yogurt was subjected to a sensory evaluation. Specifically, the intensity of sweetness when the yogurt is consumed was evaluated by relative comparison with the case in which the edible oil and fat composition prepared above (indicated in Table 5 as “rapeseed oil (containing 1 mass % of the ‘oil and fat composition of Example 17’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to plot, with discretion, evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 5

| | | Preparation | Preparation | Preparation | Preparation |
|---|---|---|---|---|---|
| | | Example | Example | Example | Example |
| | | 2-1 | 2-2 | 2-3 | 2-4 |
| Yogurt | | 99 | 99 | 99 | 99 |
| Rapeseed oil | | 1 | 0.99 | 0.9 | 0 |
| Rapeseed oil | | 0 | 0.01 | 0.1 | 1 |
| (containing 1 mass | | | | | |
| % of the “oil and | | | | | |
| fat composition of | | | | | |
| Example 17”) | | | | | |
| Total (parts by mass) | | 100 | 100 | 100 | 100 |
| Carotenoid content* | | 0 | 6.0 × 10⁻⁵ | 6.0 × 10⁻⁴ | 6.0 × 10⁻³ |
| (mass ppm) | | | | | |
| Result of | Panel 1 | 0 | 0 | 0 | 0.6 |
| sensory | Panel 2 | 0 | 0.6 | 0.9 | 1.2 |
| evaluation | Panel 3 | 0 | 0 | 0 | 0.6 |

| | | | | |
|---|---|---|---|---|
| Average value | 0 | 0.2 | 0.3 | 0.8 |

*Carotenoid content in the yogurt: Amount converted to the amount prior to heat treatment

As a result, it is apparent that the sweetness of the yogurt can be enhanced in a dosage-dependent fashion by the rapeseed oil-based edible oil and fat composition containing 1 mass % of the oil and fat composition (Example 17) with which the sweetness was enhanced by adding the composition to the corn soup in Test Example 1.

### Test Example 3

(Evaluation with Lacto Ice Cream)

<Preparation and Evaluation of Lacto Ice Cream>

The edible oil and fat composition prepared in Text Example 2 (indicated in Table 6 as “rapeseed oil (containing 1 mass % of the ‘oil and fat composition of Example 17’)”) with the blends shown in Table 6 was included in lacto ice cream (Meiji Essel Super Cup, manufactured by Meiji Co., Ltd.) to prepare lacto ice cream, and the resulting lacto ice cream was subjected to a sensory evaluation. Specifically, the intensity of sweetness when the lacto ice cream is consumed was evaluated by relative comparison with the case in which the edible oil and fat composition prepared in Test Example 2 (indicated in Table 6 as “rapeseed oil (containing 1 mass % of the ‘oil and fat composition of Example 17’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 6

| | | Preparation | Preparation | Preparation | Preparation |
|---|---|---|---|---|---|
| | | Example | Example | Example | Example |
| Preparation | | 3-1 | 3-2 | 3-3 | 3-4 |
| Lacto ice cream | | 99 | 99 | 99 | 99 |
| Rapeseed oil | | 1 | 0.99 | 0.9 | 0 |
| Rapeseed oil | | 0 | 0.01 | 0.1 | 1 |
| (containing 1 | | | | | |
| mass % of the | | | | | |
| “oil and fat | | | | | |
| composition of | | | | | |
| Example 17”) | | | | | |
| Total (parts by | | 100 | 100 | 100 | 100 |
| mass) | | | | | |
| Carotenoid content* | | 0 | 6.0 × 10⁻⁵ | 6.0 × 10⁻⁴ | 6.0 × 10⁻³ |
| (mass ppm) | | | | | |
| Result of | Panel 1 | 0 | 0.6 | 2.1 | 3 |
| sensory | Panel 2 | 0 | 1.8 | 2.4 | 3 |
| evaluation | Panel 3 | 0 | 1.2 | 2.4 | 3 |

| | | | | |
|---|---|---|---|---|
| Average value | 0 | 1.2 | 2.3 | 3 |

*Carotenoid content in the lacto ice cream: Amount converted to the amount prior to heat treatment

As a result, it is apparent that the sweetness of the lacto ice cream can be enhanced in a dosage-dependent fashion by the rapeseed oil-based edible oil and fat composition containing 1 mass % of the oil and fat composition (Example 17) with which the sweetness was enhanced by adding the composition to the corn soup in Test Example 1.

### Test Example 4

(Evaluation with Whipped Cream)

<Preparation and Evaluation of Whipped Cream>

The edible oil and fat composition prepared in Test Example 2 (indicated in Table 7 as “rapeseed oil (containing 1 mass % of the ‘oil and fat composition of Example 17’)”) with the blends shown in Table 7 was included in vegetable cream (whipped vegetable fat, manufactured by Megmilk Snow Brand Co., Ltd.) to prepare whipped cream, and the resulting whipped cream was subjected to a sensory evaluation. Specifically, the intensity of sweetness when the whipped cream is consumed was evaluated by relative comparison with the case in which the edible oil and fat composition prepared in Test Example 2 (indicated in Table 7 as “rapeseed oil (containing 1 mass % of the ‘oil and fat composition of Example 17’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 7

| | | Preparation | Preparation | Preparation | Preparation | Preparation | Preparation |
|---|---|---|---|---|---|---|---|
| | | Example 4-1 | Example 4-2 | Example 4-3 | Example 4-4 | Example 4-5 | Example 4-6 |
| Vegetable cream | | 183 | 183 | 183 | 183 | 183 | 183 |
| Granulated sugar | | 15 | 15 | 15 | 15 | 15 | 15 |
| Rapeseed oil | | 2 | 1.9998 | 1.998 | 1.98 | 1.8 | 0 |
| Rapeseed oil (containing 1 mass % | | 0 | 0.0002 | 0.002 | 0.02 | 0.2 | 2 |
| of the “oil and fat composition | | | | | | | |
| of Example 17”) | | | | | | | |
| Total (parts by mass) | | 200 | 200 | 200 | 200 | 200 | 200 |
| Carotenoid content* (mass ppm) | | 0 | 6.0 × 10⁻⁶ | 6.0 × 10⁻⁵ | 6.0 × 10⁻⁴ | 6.0 × 10⁻³ | 6.0 × 10⁻² |
| Result of | Panel 1 | 0 | 1 | 1.6 | 1.8 | 1.8 | 2.4 |
| sensory | Panel 2 | 0 | 1 | 1.3 | 1.8 | 2.1 | 2.4 |
| evaluation | Panel 3 | 0 | 1 | 1.5 | 1.8 | 2.4 | 3 |

| | | | | | | |
|---|---|---|---|---|---|---|
| Average value | 0 | 1 | 1.5 | 1.8 | 2.1 | 2.6 |

*Carotenoid content in the whipped cream: Amount converted to the amount prior to heat treatment

As a result, it is apparent that the sweetness of the whipped cream can be enhanced in a dosage-dependent fashion by the rapeseed oil-based edible oil and fat composition containing 1 mass % of the oil and fat composition (Example 17) with which the sweetness was enhanced by adding the composition to the corn soup in Test Example 1.

### Test Example 5

(Evaluation with Coffee Drink)

<Preparation of Powdered Oil and Fat>

The oil and fat composition of Example 17 prepared in Test Example 1 was admixed at 1 mass % in a powdered oil and fat, and the powdered oil and fat containing a carotenoid-derived product content of 6.0×10⁻⁵ mass % as an amount expressed as the carotenoid amount prior to heat treatment was prepared. The powdered oil and fat was prepared using the method of paragraph [0046] of JP 2017-63784 A to admix 1 mass % of the oil and fat composition (Example 17). Moreover, a powdered oil and fat (plain) containing no oil and fat composition was prepared by the same method.

(Preparation and Evaluation of a Coffee Drink)

A coffee drink was prepared with a blending ratio of 0.6 mass % of powdered coffee (Blendy, manufactured by Ajinomoto AGF Co., Ltd.), 2.6 mass % of granulated sugar, 2.9 mass % of powdered oil and fat (plain), and 93.9 mass % of hot water. Furthermore, the powdered oil and fat prepared above (indicated in Table 8 as “powdered oil and fat (containing 1 mass % of the ‘oil and fat composition of Example 17’)”) and a powdered oil and fat (plain) were included in the coffee drink with the blends shown in Table 8 to prepare the coffee drink, and the resulting coffee drink was subjected to a sensory evaluation. Specifically, the intensity of sweetness when the coffee drink is consumed was evaluated by relative comparison with the case in which the powdered oil and fat prepared above (indicated in Table 8 as “powdered oil and fat (containing 1 mass % of the ‘oil and fat composition of Example 17’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 8

| | | Preparation | Preparation | Preparation | Preparation |
|---|---|---|---|---|---|
| | | Example | Example | Example | Example |
| Preparation | | 5-1 | 5-2 | 5-3 | 5-4 |
| Coffee drink | | 99 | 99 | 99 | 99 |
| Powdered oil and | | 1 | 0.99 | 0.9 | 0 |
| fat (plain) | | | | | |
| Powdered oil and | | 0 | 0.01 | 0.1 | 1 |
| fat (containing 1 | | | | | |
| mass % of the “oil | | 0 | 0.01 | 0.1 | 1 |
| and fat composition | | | | | |
| of Example 17”) | | | | | |
| Total (parts by | | 100 | 100 | 100 | 100 |
| mass) | | | | | |
| Carotenoid content* | | 0 | 6.0 × 10⁻⁵ | 6.0 × 10⁻⁴ | 6.0 × 10⁻³ |
| (mass ppm) | | | | | |
| Result of | Panel 1 | 0 | 0.6 | 1.2 | 1.8 |
| sensory | Panel 2 | 0 | 0.6 | 1.2 | 1.8 |
| evaluation | Panel 3 | 0 | 1.2 | 1.5 | 1.5 |

| | | | | |
|---|---|---|---|---|
| Average value | 0 | 0.8 | 1.3 | 1.7 |

*Carotenoid content in the coffee drink: Amount converted to the amount prior to heat treatment

As a result, it is apparent that the sweetness of the coffee drink can be enhanced in a dosage-dependent fashion by the powdered oil and fat containing 1 mass % of the oil and fat composition (Example 17) with which the sweetness was enhanced by adding the composition to the corn soup in Test Example 1.

### Test Example 6

(Evaluation with Madeleine)

<Preparation of a Madeleine Dough>

A madeleine dough was prepared according to the blend shown in Table 9.

TABLE 9
(Madeleine dough)

| Starting material | Blend (parts by mass) |
|---|---|
| Egg | 100 |
| Sugar | 100 |
| Flour | 100 |
| Baking powder | 1.5 |
| Butter | 100 |
| Total | 401.5 |

Specifically, eggs were whipped in a bowl, sugar was added, the sugar was melted in a hot water bath and removed from the hot water bath, and flour and baking powder were added. The combination was mixed until smooth, melted butter was added in small amounts (3-4 times), and the combination was mixed to make dough. The dough was allowed to rest for 30 minutes to 1 hour.

<Preparation and Evaluation of a Madeleine>

The powdered oil and fat prepared in Test Example 5 (indicated in Table 10 as “powdered oil and fat (containing 1 mass % of the ‘oil and fat composition of Example 17’)”) or a powdered oil and fat (plain) were used with the blends shown in Table 10 to prepare the madeleine. Specifically, the dough prepared above was divided into 45 g pieces and mixed with the powdered oil and fat and powdered oil and fat (plain), the dough was placed in a mold so as to form 6 or 7 portions, the mold was lightly tapped so as to flatten the dough, and the mold was placed in a warmed oven and baked at 170° C. for about 15 minutes to obtain madeleines.

The resulting madeleine was subjected to a sensory evaluation. Specifically, the intensity of sweetness when the madeleine is consumed was evaluated by relative comparison with the case in which the powdered oil and fat prepared Test Example 5 (indicated in Table 10 as “powdered oil and fat (containing 1 mass % of the ‘oil and fat composition of Example 17’)”) was not added. The sensory evaluation was conducted by an expert panel of three people using an evaluation sheet in which the scores of −3, −2, −1, 0, 1, 2, and 3 indicating the following criteria were drawn on a 6 cm line segment at 1 cm intervals. Specifically, the expert panel was asked to arbitrarily plot evaluations on the line segment, the length from the evaluation score 0 was measured in units of 0.1 cm, and the length was taken as the evaluation value of each expert panel.

(Criteria)

3 Very intense

2 Intense

1 Somewhat intense

0 Same

−1 Somewhat weak

−2 Weak

−3 Very weak

TABLE 10

| | | Preparation | Preparation | Preparation | Preparation |
|---|---|---|---|---|---|
| | | Example | Example | Example | Example |
| Preparation | | 6-1 | 6-2 | 6-3 | 6-4 |
| Madeleine dough | | 45 | 45 | 45 | 45 |
| Powdered oil and | | 5 | 4.95 | 4.5 | 0 |
| fat | | | | | |
| Powdered oil and | | 0 | 0.05 | 0.5 | 5 |
| fat (containing 1 | | | | | |
| mass % of the “oil | | | | | |
| and fat composition | | | | | |
| of Example 17”) | | | | | |
| Total (parts by | | 50 | 50 | 50 | 50 |
| mass) | | | | | |
| Carotenoid content* | | 0 | 6.0 × 10⁻⁴ | 6.0 × 10⁻³ | 6.0 × 10⁻² |
| (mass ppm) | | | | | |
| Result of | Panel 1 | 0 | 0 | 1.5 | 2 |
| sensory | Panel 2 | 0 | 0.5 | 2 | 3 |
| evaluation | Panel 3 | 0 | 1.5 | 2 | 2 |

| | | | | |
|---|---|---|---|---|
| Average value | 0 | 0.7 | 1.8 | 2.3 |

*Carotenoid content in the madeleine dough: Amount converted to the amount prior to heat treatment

As a result, it is apparent that the sweetness of the madeleine can be enhanced in a dosage-dependent fashion by the powdered oil and fat containing 1 mass % of the oil and fat composition (Example 17) with which the sweetness was enhanced by adding the composition to the corn soup in Test Example 1.

### Test Example 7

(Sensory Evaluation of Sweetness of Chocolate by the Time Intensity Method)

(Preparation and Evaluation of Chocolate)

Chocolate was prepared according to the blends shown in Table 11. Specifically, commercially available chocolate (Meiji Black Chocolate, manufactured by Meiji Co., Ltd.) was melted in a hot water bath, and the oil and fat composition of Example 10 prepared in Test Example 1 or rapeseed oil as a comparison was added so as to have a content of 0.2 mass %. The combination was introduced into a mold and hardened in a refrigerator to prepare chocolate. The resulting chocolate was subjected to a sensory evaluation of chocolate sweetness using the Time Intensity method. In the Time Intensity method, an evaluator operates an evaluation scale bar connected to a computer, whereby the sweetness perceived during the measurement is continuously evaluated, and the change in the intensity of the sweetness over time is measured. In the present test example, chocolate was put into the mouth five seconds after the start of measurement, and the chocolate was chewed at a pace of 2 times per second from the start of measurement to 15 seconds and then swallowed. The measurement was further continued until 60 seconds after the start of measurement, and the measurement was completed.

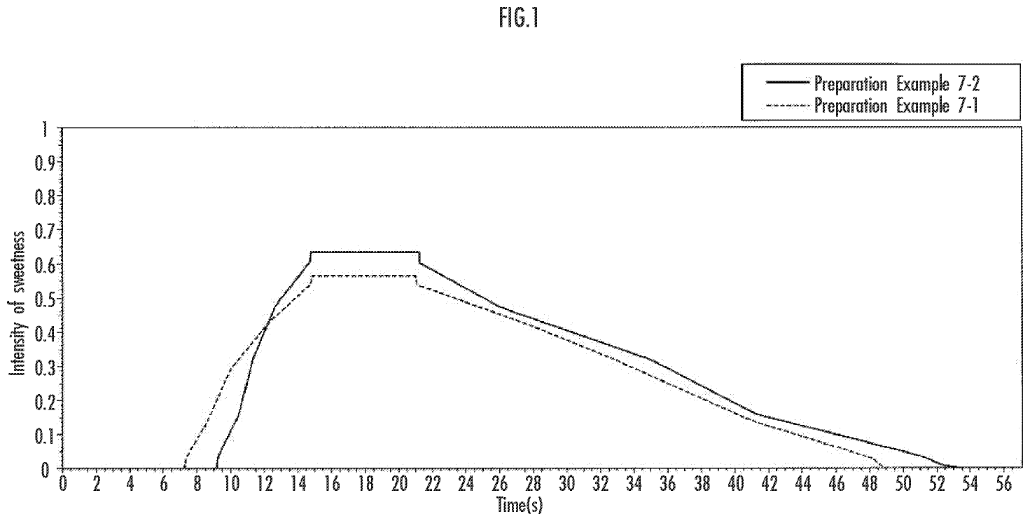

FIG. 1 shows the results of a sensory evaluation by the Time Intensity method.

TABLE 11

| | | Preparation | |
|---|---|---|---|
| | Preparation Example 7-1 | Example 7-2 | |
| Chocolate | 49.9 | 49.9 | |
| Rapeseed oil | 0.1 | 0 | |
| Powdered oil and fat | 0 | 0.1 | |
| composition of | | | |
| Example 10 | | | |
| Total (parts by mass) | 50 | 50 | |
| Carotenoid content* (mass ppm) | 0 | 1.06 × 10⁻¹ | |
| Result of the sensory | Maximum sweetness intensity | 0.57 | 0.63 |
| evaluation by the | Duration (s) of maximum | 6.1 | 6.4 |
| Time Intensity | sweetness intensity | | |
| method | | | |

*Carotenoid content in the chocolate: Amount converted to the amount prior to heat treatment

As a result, in Preparation Example 7-1 in which rapeseed oil was blended with chocolate, the maximum sweetness intensity was 0.57 and the duration was 6.1 seconds, whereas in Preparation Example 7-2 in which in the oil and fat composition of Example 10 containing a carotenoid decomposition product, the maximum sweetness intensity was 0.63 and the duration was 6.4 seconds. Consequently, it is apparent that the intensity of the sweetness of chocolate is intensified and the duration of maximum sweetness intensity can be increased by including a carotenoid decomposition product in the chocolate.

1. A method for producing an oil and fat composition, characterized in comprising a step for adding a carotenoid to an edible oil and fat, and a step for decomposing the carotenoid in the edible oil and fat.

2. The method for producing an oil and fat composition according to claim 1, wherein the carotenoid is one or more selected from the group consisting of β-carotene, α-carotene, retinol, lutein, canthaxanthin, β-cryptoxanthin, bixin, norbixin, astaxanthin, zeaxanthin, fucoxanthin, violaxanthin, lycopene, crocin, crocetin, and capsanthin.

3. The method for producing an oil and fat composition according to claim 1, wherein, in the step for adding, 0.003 mass % or more and 3 mass % or less of the carotenoid is added to the edible oil and fat.

4. The method for producing an oil and fat composition according to claim 1, wherein the edible oil and fat has an iodine value of 0 or more and 140 or less.

5. The method for producing an oil and fat composition according to claim 1, wherein the edible oil and fat is one or more selected from the group consisting of medium-chain fatty acid triglycerides, coconut oil, palm mid fraction (sPMF), fully hydrogenated palm kernel oil, rapeseed oil, and palm olein.

6. The method for producing an oil and fat composition according to claim 1, wherein the step for decomposition is carried out at a heating temperature of 50° C. or higher and 220° C. or lower, and a heating time of 0.1 hour or more and 240 hours or less.

7. The method for producing an oil and fat composition according to claim 1, wherein the step for decomposition is carried out by supplying oxygen to the edible oil and fat.

8. A method for producing an edible oil and fat composition, comprising a step for adding the oil and fat composition obtained by the production method of claim 1 to an edible oil and fat.

9. The method for producing an edible oil and fat composition according to claim 8, wherein an amount of 1×10⁻¹⁰ mass % or more and less than 100 mass % of the oil and fat composition is added.

10. A method for producing a food, comprising a step for admixing, in a food, the oil and fat composition obtained by the production method of claim 1.

11. The method for producing a food according to claim 10, wherein 1×10⁻¹⁰ mass % or more and 50 mass % or less of the oil and fat composition is added.

12. A method for enhancing food sweetness, wherein an oil and fat composition obtained by the production method of claim 1.

13. The method according to claim 12, wherein the oil and fat composition is included in the food so that the total amount of the carotenoid and a decomposition product thereof is 1×10⁻¹⁵ mass % or more and 1.5 mass % or less as an amount expressed as the carotenoid amount prior to the decomposition step.

14. A composition for enhancing food sweetness containing a carotenoid decomposition product.

15. The composition according to claim 14, wherein the carotenoid is one or more selected from the group consisting of β-carotene, α-carotene, retinol, lutein, canthaxanthin, β-cryptoxanthin, bixin, norbixin, astaxanthin, zeaxanthin, fucoxanthin, violaxanthin, lycopene, crocin, crocetin, and capsanthin.

16. A method for producing a food, comprising a step for admixing, in a food, the edible oil and fat composition obtained by the production method of claim 8.

17. The method for producing a food according to claim 16, wherein 1×10⁻¹⁰ mass % or more and 50 mass % or less of the edible oil and fat composition is added.

18. A method for enhancing food sweetness, wherein an edible oil and fat composition obtained by the production method of claim 8 is included in a food.

19. The method according to claim 18, wherein the edible oil and fat composition is included in the food so that the total amount of the carotenoid and a decomposition product thereof is 1×10⁻¹⁵ mass % or more and 1.5 mass % or less as an amount expressed as the carotenoid amount prior to the decomposition step.
